(19) United States
(12) Patent Application Publication
(10) Pub. No.: US 2018/0106949 A1
(43) Pub. Date: Apr. 19, 2018

(54) BACKLIGHT MODULE AND LIQUID CRYSTAL DISPLAY DEVICE

(71) Applicant: Wuhan China Star Optoelectronics Technology Co., Ltd., Wuhan City (CN)

(72) Inventors: Yan Cheng, Wuhan City (CN); Gege Zhou, Wuhan City (CN)

(21) Appl. No.: 15/109,127

(22) PCT Filed: May 25, 2016
(86) PCT No.: PCT/CN2016/083387

§ 371 Date: Jun. 30, 2016

(30) Foreign Application Priority Data
May 9, 2016 (CN) 2016103025743

(51) Int. Cl. F21V 8/00

(52) U.S. Cl. CPC G02B 6/0053; G02B 6/0055; G02B 6/0065; G02B 6/0088; G02B 6/0051

(57) ABSTRACT

The present invention provides a backlight module and a liquid crystal display device. The backlight module of the present invention includes an upper brightness enhancement film (7), which includes a central zone (71) and a lens zone (72) located between the central zone (71) and a mold frame (1). The upper brightness enhancement film (7) includes a prism structure formed on an upper surface of the central zone (71); and the upper brightness enhancement film (7) includes a lens structure formed on an upper surface of the lens zone (72). The lens structure includes a plurality of concave surfaces (721) arranged in sequence in a side-by-side manner from an edge of the upper brightness enhancement film (7) toward interior thereof. The prism structure and the lens structure of the upper brightness enhancement film (7) are integrally formed together. The lens structure of the upper brightness enhancement film (7) helps diverge light projecting outward so as to have a part of the light extending over and covering a portion of an area shielded by the light-shielding tape (8), expanding a view area of the backlight module to thereby achieving a visual effect of narrowing bezel. Further, the manufacturing process is simplified, the manufacturing cost is reduced, and product yield is increased.

### BACKGROUND OF THE INVENTION

### 1. Field of the Invention

The present invention relates to the field of liquid crystal display technology, and in particular to a backlight module and a liquid crystal display device.

### 2. The Related Arts

Liquid crystal displays (LCDs) have a variety of advantages, such as thin device body, low power consumption, and being free of radiation, and thus have wide applications, such as liquid crystal televisions, mobile phones, personal digital assistants (PDAs), digital cameras, computer monitors, and notebook computer screens, so as to take a leading position in the field of flat panel displays. Most of the LCDs that are currently available in the market are backlighting LCDs, which comprise a liquid crystal display panel and a backlight module. The liquid crystal display panel is commonly made up of a color filter substrate, a thin-film transistor (TFT) array substrate, and a liquid crystal layer arranged between the two substrates and the working principle of the liquid crystal display panel is that a drive voltage is applied to the two glass substrates to control rotation of liquid crystal molecules of the liquid crystal layer in order to refract out light from the backlight module to generate an image. Since the liquid crystal panel itself does not emit light, light must be provided from the backlight module in order to normally display images. Thus, the backlight module is one of the key components of the liquid crystal displays. Narrow bezel liquid crystal display screens are now a major trend of development of high quality display screens due to various advantages, including being simple and good looking and having a large viewable area for same size.

Referring to FIG. 1, a schematic view is given to show the structure of a conventional backlight module that comprises a mold frame 1′, a light guide plate 2′ disposed inside the mold frame 1′, a reflector plate 3′ disposed under the mold frame 1′ and the light guide plate 2′, a diffusion plate 5′ disposed on an upper surface of the light guide plate 2′, a lower brightness enhancement film 6′ disposed on an upper surface of the diffusion plate 5′, an upper brightness enhancement film 7′ disposed on an upper surface of the lower brightness enhancement film 6′, and a light-shielding adhesive tape 8′ disposed on an upper surface of the mold frame 1′ and extending to cover an edge portion of the upper brightness enhancement film 7′, and a backlight source disposed between the light guide plate 2′ and the mold frame 1′. When the backlight module is in operation, light emits from the backlight source and is spread through the light guide plate 2′ and is further condensed by each film layer so as to homogenize light emission from a surface of the backlight module in the entirety thereof. As shown in FIG. 1, since exiting light is generally projected out in a manner of being substantially perpendicular to an upper surface of the upper brightness enhancement film 7′, no light covers the mold frame 1′ and the light-shielding adhesive tape 8′ so that, in the sense of visual perception, a non-display area around a periphery of a display area cannot be reduced and this is adverse to an attempt of increasing a view area (VA) of the backlight module. Heretofore, a lens structure is included by processing a glass substrate or an externally attached glass cover so as to have the non-display area along the outer periphery of the display area visually reduced thereby achieving an effect of narrowed bezel in visual perception. However, such solutions require processing of glass and this is a complicated process of high cost and may lead to reduced yield rate of glass substrates thereby further increasing the cost.

### SUMMARY OF THE INVENTION

An object of the present invention is to provide a backlight module that shows a visual effect of narrowed bezel and has a simple manufacturing process, low manufacturing cost, and high product yield rate.

Another object of the present invention is to provide a liquid crystal display device that shows a visual effect of narrowed bezel and has a simple manufacturing process, low manufacturing cost, and high product yield rate.

To achieve the above objects, the present invention provides a backlight module, which comprises: a mold frame, a light guide plate arranged inside the mold frame, a reflector plate arranged under the mold frame and the light guide plate, a diffusion plate arranged on an upper surface of the light guide plate, a lower brightness enhancement film arranged on an upper surface of the diffusion plate, an upper brightness enhancement film arranged on an upper surface of the lower brightness enhancement film, and a light-shielding tape arranged on an upper surface of the mold frame and extending to cover an edge portion of the upper brightness enhancement film;

wherein the upper brightness enhancement film comprises a central zone and a lens zone located between the central zone and the mold frame;

the lens zone is located below the light-shielding tape and extends outward in a direction toward the central zone by a predetermined distance;

the upper brightness enhancement film comprises a prism structure formed on an upper surface of the central zone;

the upper brightness enhancement film comprises a lens structure formed on an upper surface of the lens zone and the lens structure comprises a plurality of concave surfaces arranged in sequence in a side-by-side manner from an edge of the upper brightness enhancement film in a direction toward interior thereof;

the concave surfaces are trough-like surfaces extending alongside the edge of the upper brightness enhancement film and curved toward a lower surface of the upper brightness enhancement film; and

the prism structure and the lens structure of the upper brightness enhancement film are integrally formed together.

The upper brightness enhancement film is formed of a material comprising polyethylene terephthalate.

The prism structure and the lens structure of the upper brightness enhancement film are integrally formed by using the same mold.

The prism structure and the lens structure of the upper brightness enhancement film are integrally formed through a roll-to-roll manufacturing process by using a cylindrical mold.

The backlight module further comprises a double-sided adhesive tape arranged between the mold frame and the reflector plate such that the double-sided adhesive tape adhesively fixes the reflector plate to the mold frame.

The present invention also provides a liquid crystal display device, which comprises: a backlight module and a liquid crystal display panel arranged above the backlight module;

wherein the backlight module comprises: a mold frame, a light guide plate arranged inside the mold frame, a reflector plate arranged under the mold frame and the light guide plate, a diffusion plate arranged on an upper surface of the light guide plate, a lower brightness enhancement film arranged on an upper surface of the diffusion plate, an upper brightness enhancement film arranged on an upper surface of the lower brightness enhancement film, and a light-shielding tape arranged on an upper surface of the mold frame and extending to cover an edge portion of the upper brightness enhancement film;

the upper brightness enhancement film comprises a central zone and a lens zone located between the central zone and the mold frame;

the lens zone is located below the light-shielding tape and extends outward in a direction toward the central zone by a predetermined distance;

the upper brightness enhancement film comprises a prism structure formed on an upper surface of the central zone;

the upper brightness enhancement film comprises a lens structure formed on an upper surface of the lens zone and the lens structure comprises a plurality of concave surfaces arranged in sequence in a side-by-side manner from an edge of the upper brightness enhancement film in a direction toward interior thereof;

the concave surfaces are trough-like surfaces extending alongside the edge of the upper brightness enhancement film and curved toward a lower surface of the upper brightness enhancement film; and

the prism structure and the lens structure of the upper brightness enhancement film are integrally formed together.

The upper brightness enhancement film is formed of a material comprising polyethylene terephthalate.

The prism structure and the lens structure of the upper brightness enhancement film are integrally formed by using the same mold.

The prism structure and the lens structure of the upper brightness enhancement film are integrally formed through a roll-to-roll manufacturing process by using a cylindrical mold.

The backlight module further comprises a double-sided adhesive tape arranged between the mold frame and the reflector plate such that the double-sided adhesive tape adhesively fixes the reflector plate to the mold frame.

The present invention further provides a backlight module, which comprises: a mold frame, a light guide plate arranged inside the mold frame, a reflector plate arranged under the mold frame and the light guide plate, a diffusion plate arranged on an upper surface of the light guide plate, a lower brightness enhancement film arranged on an upper surface of the diffusion plate, an upper brightness enhancement film arranged on an upper surface of the lower brightness enhancement film, and a light-shielding tape arranged on an upper surface of the mold frame and extending to cover an edge portion of the upper brightness enhancement film;

wherein the upper brightness enhancement film comprises a central zone and a lens zone located between the central zone and the mold frame;

the lens zone is located below the light-shielding tape and extends outward in a direction toward the central zone by a predetermined distance;

the upper brightness enhancement film comprises a prism structure formed on an upper surface of the central zone;

the upper brightness enhancement film comprises a lens structure formed on an upper surface of the lens zone and the lens structure comprises a plurality of concave surfaces arranged in sequence in a side-by-side manner from an edge of the upper brightness enhancement film in a direction toward interior thereof;

the concave surfaces are trough-like surfaces extending alongside the edge of the upper brightness enhancement film and curved toward a lower surface of the upper brightness enhancement film; and

the prism structure and the lens structure of the upper brightness enhancement film are integrally formed together;

wherein the upper brightness enhancement film is formed of a material comprising polyethylene terephthalate; and

wherein the prism structure and the lens structure of the upper brightness enhancement film are integrally formed by using the same mold.

The efficacy of the present invention is that the present invention provides a backlight module, in which an upper brightness enhancement film comprises a central zone and a lens zone located between the central zone and a mold frame. The upper brightness enhancement film comprises a prism structure formed on an upper surface of the central zone; and the upper brightness enhancement film comprises a lens structure formed on an upper surface of the lens zone so that light emitting from the backlight source, after being reflected by a reflector plate, guided by a light guide plate, spread by a diffusion plate, and condensed by a lower brightness enhancement film, gets incident onto the upper brightness enhancement film and is projected out in a divergent manner from the lens zone of the upper brightness enhancement film to extend over and cover a part of an area shielded by the light-shielding tape and expand a view area of the backlight module thereby achieving a visual effect of narrowing bezel. Further, the prism structure and the lens structure of the upper brightness enhancement film are integrally formed so that the manufacturing process is simplified, the manufactured cost reduced, and product yield increased. The present invention provides a liquid crystal display device that provides a visual effect of bezel narrowing and has a simple manufacturing process, a reduced manufacturing cost, and a high product yield rate.

### BRIEF DESCRIPTION OF THE DRAWINGS

The features and technical contents of the present invention will be better understood by referring to the following detailed description and drawings the present invention. However, the drawings are provided for the purpose of reference and illustration and are not intended to limit the scope of the present invention.

In the drawing:

FIG. 1 is a schematic view illustrating the structure of a conventional backlight module;

FIG. 2 is a schematic view illustrating the structure of a backlight module according to the present invention;

FIG. 3 is an enlarged view showing a portion of a lens zone of a brightness enhancement film of the backlight module according to the present invention; and

FIG. 4 is a schematic view illustrating the structure of a liquid crystal display device according to the present invention.

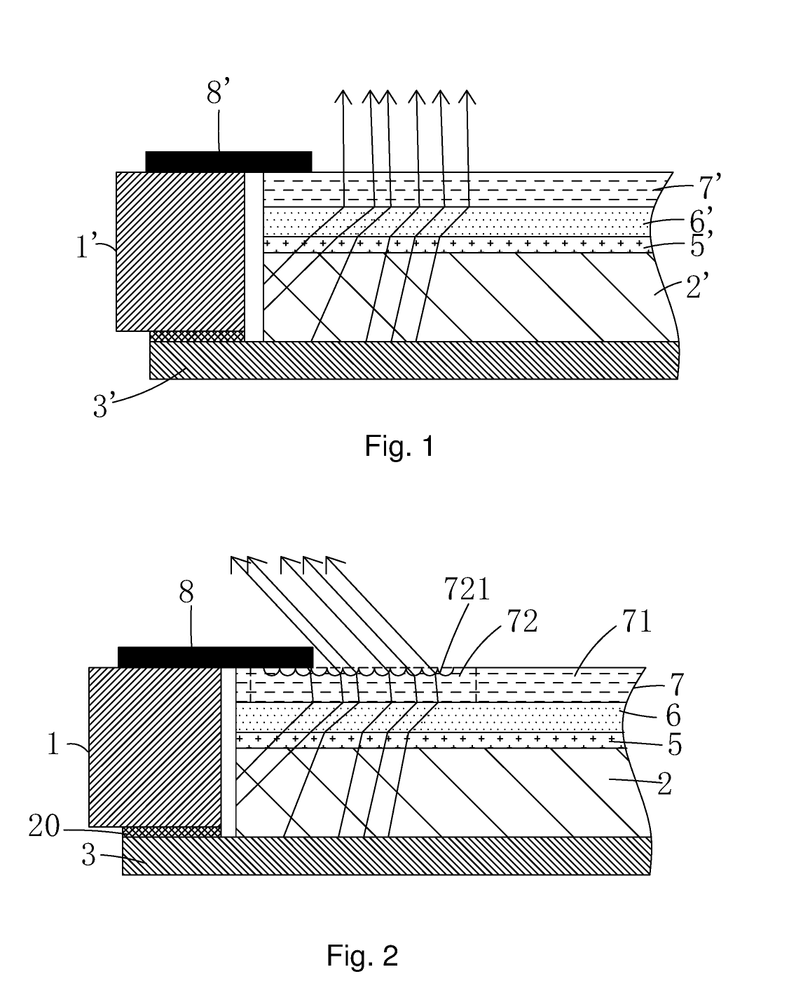

### DETAILED DESCRIPTION OF THE PREFERRED EMBODIMENTS

To further expound the technical solution adopted in the present invention and the advantages thereof, a detailed description is given to a preferred embodiment of the present invention with reference to the attached drawings.

Referring to FIG. 2, the present invention provides a backlight module, which comprises: a mold frame 1, a light guide plate 2 arranged inside the mold frame 1, a reflector plate 3 arranged under the mold frame 1 and the light guide plate 2, a diffusion plate 5 arranged on an upper surface of the light guide plate 2, a lower brightness enhancement film 6 arranged on an upper surface of the diffusion plate 5, an upper brightness enhancement film 7 arranged on an upper surface of the lower brightness enhancement film 6, and a light-shielding tape 8 arranged on an upper surface of the mold frame 1 and extending to cover an edge portion of the upper brightness enhancement film 7.

Specifically, the backlight module further comprises a backlight source. The backlight source can be a side-edge backlight source arranged between the light guide plate 2 and the mold frame 1 or can alternatively be a direct backlight source arranged between the light guide plate 2 and the reflector plate 3.

Specifically, a double-sided adhesive tape 20 is arranged between the mold frame 1 and the reflector plate 3 to adhesively fix the mold frame 1 and the reflector plate 3 together.

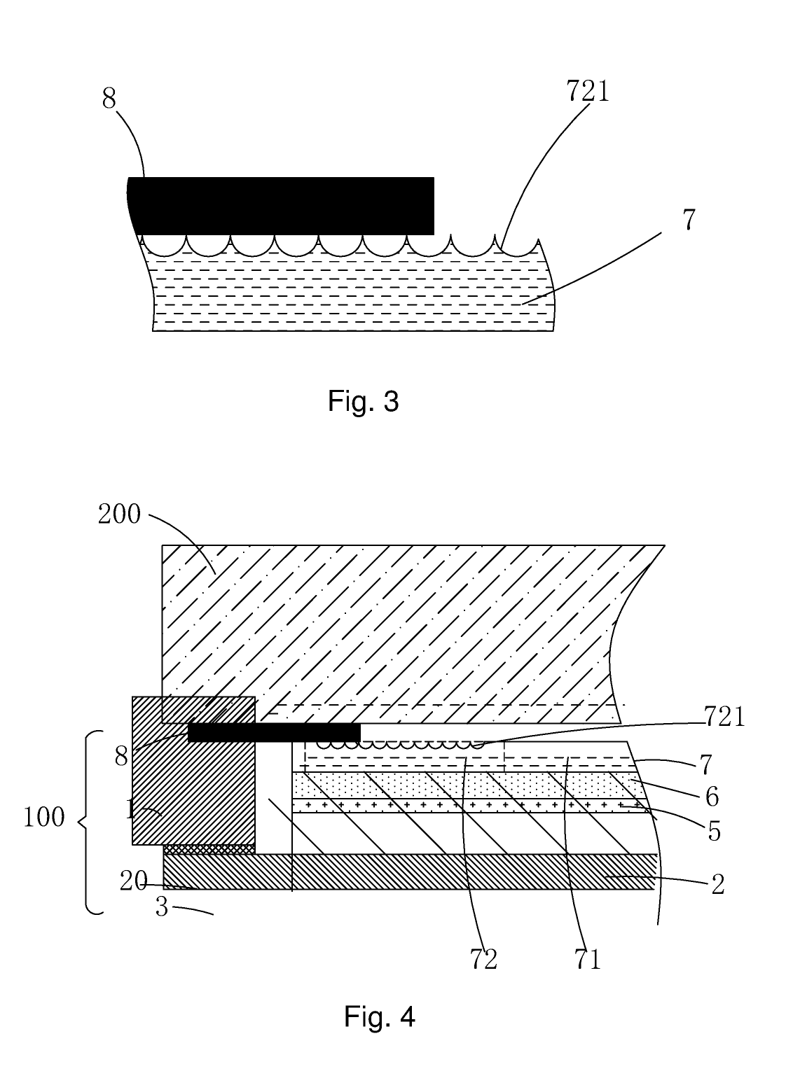

It is noted that, with reference to FIGS. 2 and 3, the upper brightness enhancement film 7 comprises a central zone 71 and a lens zone 72 located between the central zone 71 and the mold frame 1.

Specifically, the upper brightness enhancement film 7 comprises a prism structure formed on an upper surface of the central zone 71; and the upper brightness enhancement film 7 comprises a lens structure formed on an upper surface of the lens zone 72. The lens structure comprises a plurality of concave surfaces 721 arranged in sequence in a side-by-side manner from an edge of the upper brightness enhancement film 7 in a direction toward interior thereof.

Specifically, the concave surfaces 721 are trough-like surfaces extending alongside the edge of the upper brightness enhancement film 7 and curved toward a lower surface of the upper brightness enhancement film 7.

Specifically, the prism structure and the lens structure of the upper brightness enhancement film 7 are integrally formed as a unitary structure.

Preferably, the upper brightness enhancement film 7 is formed of a material comprising polyethylene terephthalate (PET), which is easy to process and mold so as to ease the formation of the concave surfaces 721 and enhance the operability of production.

Preferably, the prism structure and the lens structure of the upper brightness enhancement film 7 are integrally formed by using the same mold. Specifically, a flat plate mold may be used for the integrated formation through imprinting or a cylindrical mold is used for the integrated formation through a roll-to-roll manufacturing process.

Specifically, referring to FIG. 2, the lens zone 72 is located below the light-shielding tape 8 and extends outwards in a direction toward the central zone 71 by a predetermined distance such that a width of the lens zone 72 is greater than a width of a portion the light-shielding tape 8 that covers the upper surface of the upper brightness enhancement film 7.

Specifically, when the backlight module of the present invention is in operation, the backlight source emits light and the light is reflected by the reflector plate 3 and guided by the light guide plate 2 and spread by the diffusion plate 5 to get incident onto the lower brightness enhancement film 6. The lower brightness enhancement film 6 condenses and guides the light into the upper brightness enhancement film 7. In a site corresponding to an edge portion of the backlight module, namely in the lens zone 72 of the upper brightness enhancement film 7, since the concave surfaces 721 and the lower surface of the upper brightness enhancement film 7 collectively form concave lens structures, light incident onto the lens zone 72 gets divergent; and since the lens zone 72 is located below the light-shielding tape 8 and extends outside of the central zone 71 by a predetermined distance, a part of the divergent light that projects out of the upper brightness enhancement film 7 may extend over and cover a shielding portion of the light-shielding tape 8 so as to enlarge a view area of the backlight module thereby achieving a visual effect of narrowing bezel. Further, since the prism structure and the lens structure of the upper brightness enhancement film 7 are integrally formed together, there is no need to include additional manufacturing operation so that the manufacturing process is simple, the manufacturing cost is reduced, and low yield resulting from the needs for processing glass substrates can be avoided to thus further reduce the manufacturing cost.

Referring to FIG. 4, on the basis of the above-described backlight module, the present invention also provides a narrow liquid crystal display device, which comprises: a backlight module 100 and a liquid crystal display panel 200 arranged above the backlight module 100. Repeated description of the structure of the backlight module 100 will be omitted here.

Specifically, the liquid crystal display panel 200 is attached to an upper surface of the light-shielding tape 8 so as to be securely fixed to the backlight module 100.

It is noted that, referring to FIGS. 4 and 3, the upper brightness enhancement film 7 comprises a central zone 71 and a lens zone 72 located between the central zone 71 and the mold frame 1.

Specifically, the upper brightness enhancement film 7 comprises a prism structure formed on an upper surface of the central zone 71; and the upper brightness enhancement film 7 comprises a lens structure formed on an upper surface of the lens zone 72. The lens structure comprises a plurality of concave surfaces 721 arranged in sequence in a side-by-side manner from an edge of the upper brightness enhancement film 7 in a direction toward interior thereof.

Specifically, the concave surfaces 721 are trough-like surfaces extending alongside the edge of the upper brightness enhancement film 7 and curved toward a lower surface of the upper brightness enhancement film 7.

Specifically, the prism structure and the lens structure of the upper brightness enhancement film 7 are integrally formed as a unitary structure.

Preferably, the upper brightness enhancement film 7 is formed of a material comprising PET, which is easy to process and mold so as to ease the formation of the concave surfaces 721 and enhance the operability of production.

Preferably, the prism structure and the lens structure of the upper brightness enhancement film 7 are integrally formed by using the same mold. Specifically, a flat plate mold may be used for the integrated formation through imprinting or a cylindrical mold is used for the integrated formation through a roll-to-roll manufacturing process.

Specifically, referring to FIG. 4, the lens zone 72 is located below the light-shielding tape 8 and extends outwards in a direction toward the central zone 71 by a predetermined distance such that a width of the lens zone 72 is greater than a width of a portion the light-shielding tape 8 that covers the upper surface of the upper brightness enhancement film 7.

Specifically, when the liquid crystal display device of the present invention is in operation, the backlight source emits light and the light is reflected by the reflector plate 3 and guided by the light guide plate 2 and spread by the diffusion plate 5 to get incident onto the lower brightness enhancement film 6. The lower brightness enhancement film 6 condenses and guides the light into the upper brightness enhancement film 7. In a site corresponding to an edge portion of the backlight module, namely in the lens zone 72 of the upper brightness enhancement film 7, since the concave surfaces 721 and the lower surface of the upper brightness enhancement film 7 collectively form concave lens structures, light incident onto the lens zone 72 gets divergent; and since the lens zone 72 is located below the light-shielding tape 8 and extends outside of the central zone 71 by a predetermined distance, a part of the divergent light that projects out of the upper brightness enhancement film 7 may extend over and cover a shielding portion of the light-shielding tape 8 so as to enlarge a view area of the backlight module 100 and make the area of the liquid crystal display panel 200 where the light gets incident expanded whereby the liquid crystal display device achieves a visual effect of narrowing bezel. Further, since the prism structure and the lens structure of the upper brightness enhancement film 7 are integrally formed together, there is no need to include additional manufacturing operation so that the manufacturing process is simple, the manufacturing cost is reduced, and low yield resulting from the needs for processing glass substrates can be avoided to thus further reduce the manufacturing cost.

In summary, the present invention provides a backlight module, in which an upper brightness enhancement film comprises a central zone and a lens zone located between the central zone and a mold frame. The upper brightness enhancement film comprises a prism structure formed on an upper surface of the central zone; and the upper brightness enhancement film comprises a lens structure formed on an upper surface of the lens zone so that light emitting from the backlight source, after being reflected by a reflector plate, guided by a light guide plate, spread by a diffusion plate, and condensed by a lower brightness enhancement film, gets incident onto the upper brightness enhancement film and is projected out in a divergent manner from the lens zone of the upper brightness enhancement film to extend over and cover a part of an area shielded by the light-shielding tape and expand a view area of the backlight module thereby achieving a visual effect of narrowing bezel. Further, the prism structure and the lens structure of the upper brightness enhancement film are integrally formed so that the manufacturing process is simplified, the manufactured cost reduced, and product yield increased. The present invention provides a liquid crystal display device that provides a visual effect of bezel narrowing and has a simple manufacturing process, a reduced manufacturing cost, and a high product yield rate.

Based on the description given above, those having ordinary skills of the art may easily contemplate various changes and modifications of the technical solution and technical ideas of the present invention and all these changes and modifications are considered within the protection scope of the present invention defined in the appended claims.

What is claimed is:

1. A backlight module, comprising: a mold frame, a light guide plate arranged inside the mold frame, a reflector plate arranged under the mold frame and the light guide plate, a diffusion plate arranged on an upper surface of the light guide plate, a lower brightness enhancement film arranged on an upper surface of the diffusion plate, an upper brightness enhancement film arranged on an upper surface of the lower brightness enhancement film, and a light-shielding tape arranged on an upper surface of the mold frame and extending to cover an edge portion of the upper brightness enhancement film;
wherein the upper brightness enhancement film comprises a central zone and a lens zone located between the central zone and the mold frame;
the lens zone is located below the light-shielding tape and extends outward in a direction toward the central zone by a predetermined distance;
the upper brightness enhancement film comprises a prism structure formed on an upper surface of the central zone;
the upper brightness enhancement film comprises a lens structure formed on an upper surface of the lens zone and the lens structure comprises a plurality of concave surfaces arranged in sequence in a side-by-side manner from an edge of the upper brightness enhancement film in a direction toward interior thereof;
the concave surfaces are trough-like surfaces extending alongside the edge of the upper brightness enhancement film and curved toward a lower surface of the upper brightness enhancement film; and
the prism structure and the lens structure of the upper brightness enhancement film are integrally formed together.

2. The backlight module as claimed in claim 1, wherein the upper brightness enhancement film is formed of a material comprising polyethylene terephthalate.

3. The backlight module as claimed in claim 1, wherein the prism structure and the lens structure of the upper brightness enhancement film are integrally formed by using the same mold.

4. The backlight module as claimed in claim 3, wherein the prism structure and the lens structure of the upper brightness enhancement film are integrally formed through a roll-to-roll manufacturing process by using a cylindrical mold.

5. The backlight module as claimed in claim 1 further comprising a double-sided adhesive tape arranged between the mold frame and the reflector plate such that the double-sided adhesive tape adhesively fixes the reflector plate to the mold frame.

6. A liquid crystal display device, comprising: a backlight module and a liquid crystal display panel arranged above the backlight module;
wherein the backlight module comprises: a mold frame, a light guide plate arranged inside the mold frame, a reflector plate arranged under the mold frame and the light guide plate, a diffusion plate arranged on an upper surface of the light guide plate, a lower brightness enhancement film arranged on an upper surface of the diffusion plate, an upper brightness enhancement film arranged on an upper surface of the lower brightness enhancement film, and a light-shielding tape arranged on an upper surface of the mold frame and extending to cover an edge portion of the upper brightness enhancement film;
the upper brightness enhancement film comprises a central zone and a lens zone located between the central zone and the mold frame;
the lens zone is located below the light-shielding tape and extends outward in a direction toward the central zone by a predetermined distance;
the upper brightness enhancement film comprises a prism structure formed on an upper surface of the central zone;
the upper brightness enhancement film comprises a lens structure formed on an upper surface of the lens zone and the lens structure comprises a plurality of concave surfaces arranged in sequence in a side-by-side manner from an edge of the upper brightness enhancement film in a direction toward interior thereof;
the concave surfaces are trough-like surfaces extending alongside the edge of the upper brightness enhancement film and curved toward a lower surface of the upper brightness enhancement film; and
the prism structure and the lens structure of the upper brightness enhancement film are integrally formed together.

7. The liquid crystal display device as claimed in claim 6, wherein the upper brightness enhancement film is formed of a material comprising polyethylene terephthalate.

8. The liquid crystal display device as claimed in claim 6, wherein the prism structure and the lens structure of the upper brightness enhancement film are integrally formed by using the same mold.

9. The liquid crystal display device as claimed in claim 8, wherein the prism structure and the lens structure of the upper brightness enhancement film are integrally formed through a roll-to-roll manufacturing process by using a cylindrical mold.

10. The liquid crystal display device as claimed in claim 6, wherein the backlight module further comprises a double-sided adhesive tape arranged between the mold frame and the reflector plate such that the double-sided adhesive tape adhesively fixes the reflector plate to the mold frame.

11. A backlight module, comprising: a mold frame, a light guide plate arranged inside the mold frame, a reflector plate arranged under the mold frame and the light guide plate, a diffusion plate arranged on an upper surface of the light guide plate, a lower brightness enhancement film arranged on an upper surface of the diffusion plate, an upper brightness enhancement film arranged on an upper surface of the lower brightness enhancement film, and a light-shielding tape arranged on an upper surface of the mold frame and extending to cover an edge portion of the upper brightness enhancement film;
wherein the upper brightness enhancement film comprises a central zone and a lens zone located between the central zone and the mold frame;
the lens zone is located below the light-shielding tape and extends outward in a direction toward the central zone by a predetermined distance;
the upper brightness enhancement film comprises a prism structure formed on an upper surface of the central zone;
the upper brightness enhancement film comprises a lens structure formed on an upper surface of the lens zone and the lens structure comprises a plurality of concave surfaces arranged in sequence in a side-by-side manner from an edge of the upper brightness enhancement film in a direction toward interior thereof;
the concave surfaces are trough-like surfaces extending alongside the edge of the upper brightness enhancement film and curved toward a lower surface of the upper brightness enhancement film; and
the prism structure and the lens structure of the upper brightness enhancement film are integrally formed together;
wherein the upper brightness enhancement film is formed of a material comprising polyethylene terephthalate; and
wherein the prism structure and the lens structure of the upper brightness enhancement film are integrally formed by using the same mold.

12. The backlight module as claimed in claim 11, wherein the prism structure and the lens structure of the upper brightness enhancement film are integrally formed through a roll-to-roll manufacturing process by using a cylindrical mold.

13. The backlight module as claimed in claim 11 further comprising a double-sided adhesive tape arranged between the mold frame and the reflector plate such that the double-sided adhesive tape adhesively fixes the reflector plate to the mold frame.
